(19) United States
(12) Patent Application Publication
(10) Pub. No.: US 2012/0194570 A1
(43) Pub. Date: Aug. 2, 2012

(54) CONTROL DEVICE, ELECTRO-OPTICAL DEVICE, DRIVING METHOD FOR ELECTRO-OPTICAL DEVICE AND ELECTRONIC APPARATUS

(75) Inventors: Kota Muto, Suwa-shi (JP); Yusuke Yamada, Matsumoto-shi (JP)

(73) Assignee: Seiko Epson Corporation, Tokyo (JP)

(21) Appl. No.: 13/352,084

(22) Filed: Jan. 17, 2012

(30) Foreign Application Priority Data
Feb. 2, 2011 (JP) 2011-020762

(51) Int. Cl. G09G 5/10

(52) U.S. Cl. 345/690

(57) ABSTRACT

A control device for a display unit that includes pixels each having display elements is disclosed. The control device comprising a control unit counting sections where pixels with different gradations are placed next to each other in a predetermined region among an image to be displayed on the display unit. The control unit outputs an instruction to execute a refresh drive in the predetermined region when an integrated value of the sections exceeds a predetermined value.

### BACKGROUND

1. Technical Field

The present invention relates to technologies for reducing afterimages generated at outlines of displayed images.

2. Related Art

An electro-optical device using the memory-property of display elements such as electrophoretic elements, electronic powder-particle elements, and cholestric liquid crystal elements has been known. For the sake of simplicity of the description, let us assume that the display elements display binary values, for example, white color and black color. For example, when the entire pixels are switched to white color to perform an all-white display, a differential drive is executed. The differential drive uses the memory property of the display elements, in which white-displayed pixels in a preceding image are not driven, and black-displayed pixels other than white color in the preceding image are driven to be switched to white color (see, for example, JP-A-2007-206267).

However, in the differential drive, when the entire pixels are switched to white color, there is a problem in that an afterimage would likely be generated in the vicinity of a boundary between those of the pixels that continue to be white and those of the pixels that are switched from black to white. A similar afterimage would also likely be generated, when the entire pixels are switched to black color, in the vicinity of a boundary between those of the pixels that continue to be black and those of the pixels that are switched from white to black. Such an afterimage appears along an outline of an image before switching, and therefore may be referred to as an outline afterimage.

### SUMMARY

The invention has been made in view of the circumstance described above, and it is an object of the invention to provide a technology that reduces such afterimages as described above, and enables high-quality display.

It is thought that the afterimage described above appears because, for example, when a white pixel and a black pixel are placed next to each other, the electric field on one of the white pixel and the black pixel influences the other pixel, and the influence remains even after both of the pixels are switched to the same color. Accordingly, in order to erase the afterimage, a refresh drive may be conducted to remove the remaining influence. However, this type of refresh drive wastes power. In view of the fact that one of the major characteristics of the display element having memory property resides in low power consumption, any structure that frequently executes such refresh drive, which goes against the characteristic, is not preferable.

In accordance with an aspect of the invention, a control device for a display unit that includes pixels each having display elements is configure to output an instruction to execute a refresh drive in a predetermined region among an image to be displayed on the display unit when an integrated value that counts sections where pixels with different gradations are placed next to each other in the predetermined region exceeds a predetermined value.

In accordance with another aspect of the invention, when the integrated value exceeds the predetermined value, it is preferable that, after instructing to rewrite the entire pixels included in the predetermined region to a single gradation, rewriting pixels, among the pixels included in the predetermined region, with a gradation different from the single gradation may be instructed.

In the control device described above, when the integrated value equals to the predetermined value or less, rewriting of pixels to be changed in the predetermined region may be instructed. By the execution of the differential drive, wasteful power consumption can be suppressed.

In accordance with an another aspect of the invention, the control device described above may preferably include an extraction function that extracts sections where pixels with different gradations are placed next to each other in the predetermined region, a counting function that counts the sections extracted by the extraction function, and a judging function that judges as to whether an integrated value provided by the counting function exceeds the predetermined value.

Here, the extraction function may be configured to extract sections where pixels with different gradations are placed next to each other for the first time, after the last display of the pixels with the single gradation.

In accordance with another aspect of the invention, a control device for a display unit that includes pixels each having display elements may be configured to output an instruction to execute a refresh drive in a predetermined region among an image to be displayed on the display unit, when an integrated value that counts sections where pixels with different gradations placed next to each other change to a single gradation in the predetermined region exceeds a predetermined value. This configuration can improve the situation in which an afterimage that is not so conspicuous is reset.

In the control device described above, the predetermined region may be composed of all or a part of the plurality of pixels in the display unit. In particular, when the predetermined region is composed of a part of the pixels, afterimages can be made inconspicuous in regions where display contents are frequently changed.

It is preferable that the refresh drive may include rewriting all of the pixels included in the predetermined region to a single gradation.

It is noted that the invention is applicable not only to a control device, but also to an electro-optical device, a method for driving the electro-optical device, and an electronic apparatus having the electro-optical device.

### BRIEF DESCRIPTION OF THE DRAWINGS

FIG. 1 is a block diagram showing the structure of an electro-optical device in accordance with a first embodiment of the invention.

FIG. 2 is a diagram showing an equivalent circuit of pixels in a display unit.

FIGS. 3A and 3B are views for explaining operations of electrophoretic elements.

FIG. 4 is a flow chart showing operations of the electro-optical device in accordance with the first embodiment.

FIG. 5 is a flow chart showing an outline detection process in accordance with the first embodiment.

FIG. 6 is a diagram for explaining shifting of the target pixel in a first VRAM.

FIGS. 7A-7H are diagrams for explaining comparison with the target pixel in the first embodiment.

FIGS. 8A-8C are diagrams showing, as an example, changes in a display image on the electro-optical device in accordance with the first embodiment.

FIGS. 9A-9G are diagrams showing an example of the refresh drive in accordance with the first embodiment.

FIGS. 10A-10C are diagrams showing an example of the differential driving in accordance with the first embodiment.

FIG. 11 is a flow chart showing an outline detection process in accordance with a second embodiment.

FIG. 12 is a diagram for explaining boundary flags in accordance with the second embodiment.

FIGS. 13A-13D are diagrams for explaining comparison with the target pixel in accordance with the second embodiment.

FIG. 14 is a flow chart showing an outline detection process in accordance with a third embodiment.

FIG. 15 is a flow chart showing an outline detection process in accordance with the third embodiment.

FIGS. 16A-13H are diagrams for explaining comparison with the target pixel in accordance with the third embodiment.

FIG. 17 is a view showing a display example in accordance with an application example.

FIGS. 18A and 18B are views showing electronic apparatuses that use an electro-optical device in accordance with embodiments of the invention.

### DESCRIPTION OF EXEMPLARY EMBODIMENTS

### First Embodiment

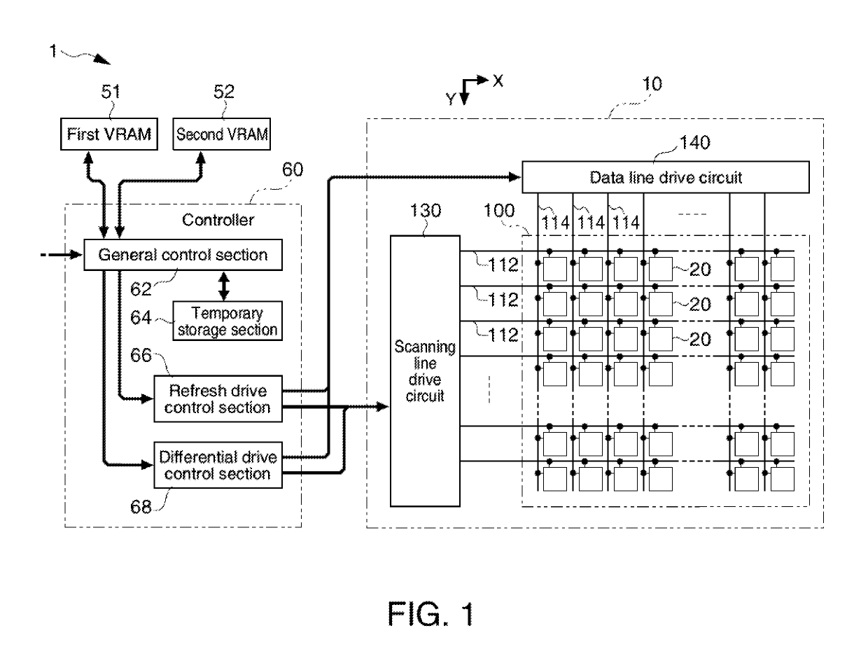

Embodiments of the invention will be described below with reference to the accompanying drawings. FIG. 1 is a block diagram showing an electrical configuration of an electro-optical device 1 in accordance with a first embodiment. As shown in FIG. 1, the electro-optical device 1 includes a display unit 10, a first VRAM 51, a second VRAM 52 and a controller 60.

The display unit 10 includes a plurality of scanning lines 112 provided along a row (X) direction, and a plurality of data lines 114 provided along a column (Y) direction in a manner to be electrically insulated from the scanning lines 112. Further, pixels 20 are provided at positions corresponding to intersections between the scanning lines 112 and the data lines 114. When the number of rows of the scanning lines 112 is “m” and the number of columns of the data lines 114 is “n,” for convenience sake, the pixels 20 form a display region 100 in which m rows in the vertical direction×n columns in the horizontal direction are arranged in a matrix.

A scanning line drive circuit 130 selects one of the m rows of scanning lines 112 according to the control by the controller 60, supplies a high (High) level signal to the selected scanning line 112, and supplies a low (Low) level signal to the other scanning lines 112. A data line drive circuit 140 drives the data lines 114 according to display contents for the pixels 20 for one row located in the selected scanning line 112.

The first VRAM 51 and the second VRAM 52 are video RAMs each having storage regions respectively corresponding to the pixels arranged in m rows×n columns, and accessed (read and written) by the controller 60. As discussed later, when the display content of the display unit 10 is changed, an image after the change is stored in the first VRAM 51, and an image prior to the change is stored in the second VRAM 52. Therefore, by comparing the content stored in the first VRAM 51 with the content stored in the second VRAM 52, pixels whose display is to be changed (to be rewritten) can be discriminated from pixels that do not require rewriting.

The controller (control device) 60 includes a general control unit 62, a temporary storage unit 64, a refresh drive control unit 66, and a differential drive control unit 68. The general control unit 62 controls each of the units, and executes a program to perform various functions to be discussed below, such as, an extraction function, a counting function, and a judging function. The temporary storage unit 64 is a RAM and temporarily stores variables to be used in operations to be discussed below. The refresh drive control unit 66 controls the scanning line drive circuit 130 and the data line drive circuit 140 to drive the entire pixels 20 by refresh drive, when a condition to be discussed below is met when an image to be displayed on the display unit 10 is changed. The differential drive control unit 68 controls the scanning line drive circuit 130 and the data line drive circuit 140 to drive only those of the pixels 20 which are changed, when a condition to be described below is not met when an image to be displayed on the display unit 10 is changed. It is noted that the controller 60 connects to a host device (e.g., CPU) whose illustration is omitted in FIG. 1, and regulates an image to be displayed on the display unit 10.

FIG. 2 is a diagram showing an equivalent circuit of the pixels 20 in the display unit 10, which shows a configuration of four (2×2) pixels in total corresponding to intersections between an i^{-th} row and an adjacent (i+1)^{-th} row on the lower side, and a j^{-th} column and an adjacent (j+1)^{-th} column on the right side. It is noted that i and (i+1) are signs that generally indicate rows of the arranged pixels 20, and are integers between 1 and m, and j and (j+1) are signs that generally indicate columns of the arranged pixels 20, and are integers between 1 and n.

As shown in FIG. 2, each of the pixels 20 includes an n-channel thin film transistor (hereafter simply abbreviated as a TFT) 22, a display element 30 and an auxiliary capacitor 40. As the pixels 20 have the same configuration, details thereof will be descried using a pixel 20 located at an intersection between the i^{-th} row and the j^{-th} column as representative. In the pixel 20 at the i^{-th} row and the j^{-th} column, the TFT 22 has a gate electrode connected to the i^{-th} scanning line 112, a source electrode connected to the j^{-th} data line 114, and a drain electrode connected to a pixel electrode 32 that is one end of the display element 30 and to one end of the auxiliary capacitor 40.

Although not particularly shown, the display unit 10 includes an element substrate with the pixel electrodes 32 formed thereon, a counter substrate with a common electrode 36 formed thereon, and an electrophoretic layer 34 having dielectric property which is held between the element substrate and the counter substrate. Therefore, the display element 30, as viewed in the equivalent circuit, defines a capacitance in which the electrophoretic layer 34 is held between the pixel electrode 32 and the common electrode 36. The display element 30 retains (stores) a voltage between the two electrodes, and performs a display to be described below according to an electric field direction generated by the retained voltage. The auxiliary capacitor 40 has a configuration in which a dielectric layer is held between a pair of electrodes formed on the side of the element substrate. An electrode on the other end of the auxiliary capacitance 40 is commonly connected to a common capacitance line 132 across each of the pixels. Also, an external circuit (not shown) applies a voltage Com to the common electrode 36, and applies a voltage Vss to the capacitance line 132. However, for the sake of simplicity of explanation, it is assumed that the voltage Com and the voltage Vss are both set at a grounding voltage that is a reference voltage (0V).

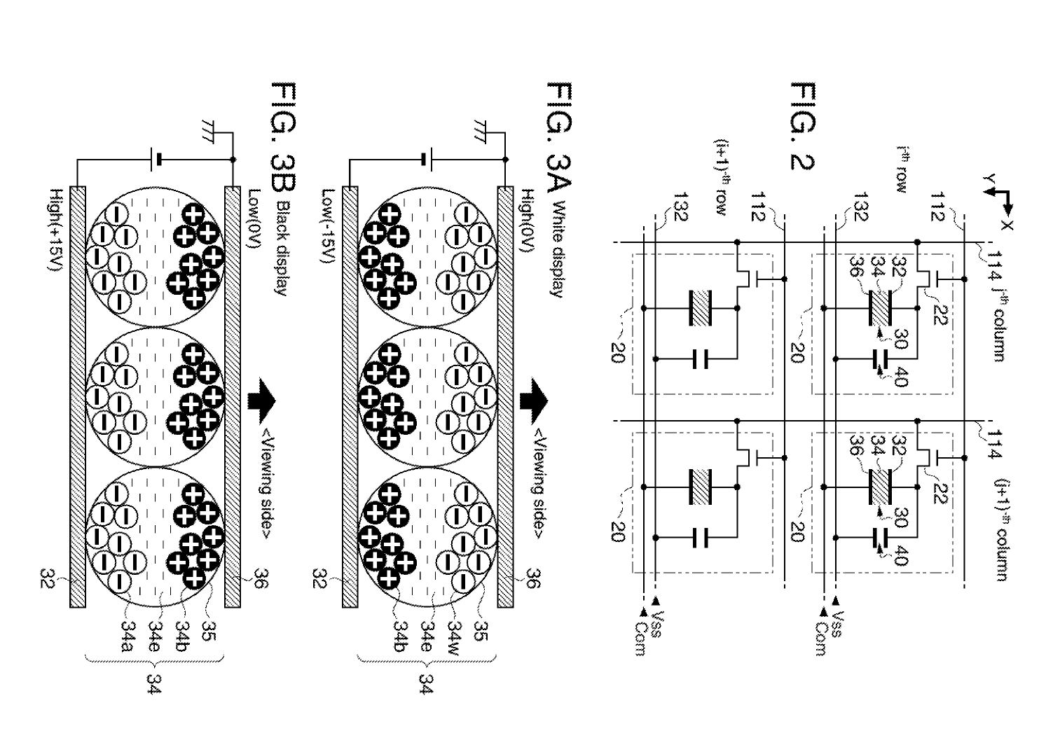

Display operations of the display element 30 are described with reference to FIGS. 3A and 3B. The electrophoretic layer 34 is a layer in which plural microcapsules 35 are fixed between the pixel electrode 32 formed on the element substrate and the common electrode 36 formed on the counter substrate. Each of the microcapsules 35 includes two kinds of electrophoretic particles moveably dispersed in a dispersion medium 34e. The two kinds of electrophoretic particles are white particles 34w that are negatively charged, and black particles 34b that are positively charged. With this configuration, as shown in FIG. 3A, when a voltage Corn, for example, 0V is applied to the common electrode 36, and a voltage, for example, −15V is applied to the pixel electrode 32, thereby maintaining the common electrode 36 relatively at a higher potential than the pixel electrode 32, the white particles 43w are drawn toward the common electrode 36 and the black particles 34b are drawn toward the pixel electrode 32. When a conductive layer having transparency such as ITO (Indium Tin Oxide) is used as the common electrode 36, and the counter substrate is configured to be transparent, the pixels 20 can be visually recognized as white as observed from the side of the common electrode 36. On the other hand, as shown in FIG. 3B, when a voltage of 0V is applied to the common electrode 36, and a voltage of, for example, +15V is applied to the pixel electrode 32, thereby maintaining the common electrode 36 relatively at a lower potential than the pixel electrode 32, the black particles 43b are drawn toward the common electrode 36 and the white particles 34w are drawn toward the pixel electrode 32. As a result, the pixels 20 can be visually recognized as black as observed from the side of the common electrode 36.

The electrophoretic layer 34 is configured in a manner that the microcapsules 35 filled with the dispersion medium 34e and containing charged particles dispersed therein are placed in a gap between two substrates (two electrodes). The electrophoretic layer 34 may be configured with charged electronic powder particles enclosed without microcapsules between the two substrates, or with cholestric liquid crystal enclosed between the two substrates. In any of the configurations, a voltage between the pixel electrode 32 and the common electrode 36 is retained, and the display is performed according to the electric field direction generated by the retained voltage.

Next, an outline of the operation of the electro-optical device 1 will be described. FIG. 4 is a flow chart showing processes (main flow) executed when the display content is changed. These processes are executed when the controller 60 receives an instruction to change the display content from the CPU that is the host system, and receives a supply of image data after change. First, in step Sa1, the general control unit 62 of the controller 60 reads image data stored in the first VRAM 51, and copies the image data onto the second VRAM 52. Next, in step Sat, the general control unit 62 stores the supplied image data after change in the first VRAM 51.

Then, in step Sa3, the general control unit 62 judges as to whether or not a variable Count exceeds a threshold value Th1. The variable Count is incremented by “1” at each occurrence of a white pixel and a black pixel being located next to each other in the vertical direction or the horizontal direction in the display content stored in the first VRAM 51, and reset to zero when a refresh drive is executed. Accordingly, the variable Count indicates an integrated value of sections in which white pixels and black pixels are positioned next to one another in the display content of the display unit 10, since the last refresh drive.

As described above, it is thought that an afterimage appears because, when a white pixel and a black pixel are placed next to each other, the electric field on one of the white pixel and the black pixel influences the other pixel, and the influence remains even after both of the pixels are switched to the same color. Accordingly, if a differential drive were executed to change the display content in a state in which the variable Count that indicates the integrated value of occurrences in which white pixels and black pixels are placed next to each other exceeds the threshold value Th1, it is presumed that an afterimage would occur to an extent that cannot be overlooked. Therefore, when it is judged in step Sa3 that the variable Count exceeds the threshold value Th1, the general control unit 62 instructs the refresh drive control unit 66, in step Sa4, to execute a refresh drive. By this, at the display unit 10, an image displayed on the display unit 10 is actually rewritten by a refresh drive to be discussed later. Thereafter, in step Sa5, the general control unit 62 resets the variable Count to zero to make it ready for the next refresh drive.

On the other hand, when the variable Count is less than the threshold value Th1, it is assumed that an afterimage would not be conspicuous even if a differential drive is executed to change the display content. Therefore, when it is judged in step Sa3 that the variable Count is less than the threshold value Th1, the general control unit 62 instructs the differential drive control unit 68, in step Sa6, to execute a differential drive. By this, at the display unit 10, an image displayed on the display unit 10 is actually rewritten by a differential drive to be discussed later.

After step Sa5 or Sa6, the general control unit 62 accesses the first VRAM 51 in step Sa7, and executes an outline detection process. After executing the outline detection process, the general control unit 62 stands by until next time it receives an instruction to change the display content from the host device CPU. Therefore, the main flow in FIG. 4 is executed each time the host device CPU issues an instruction to change the display content.

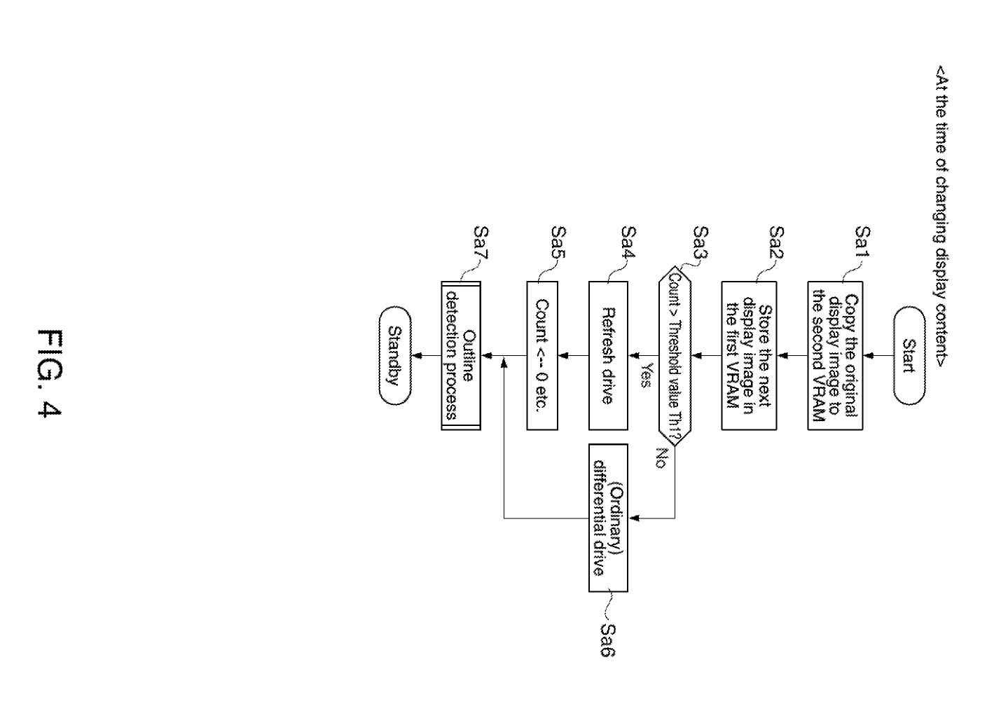

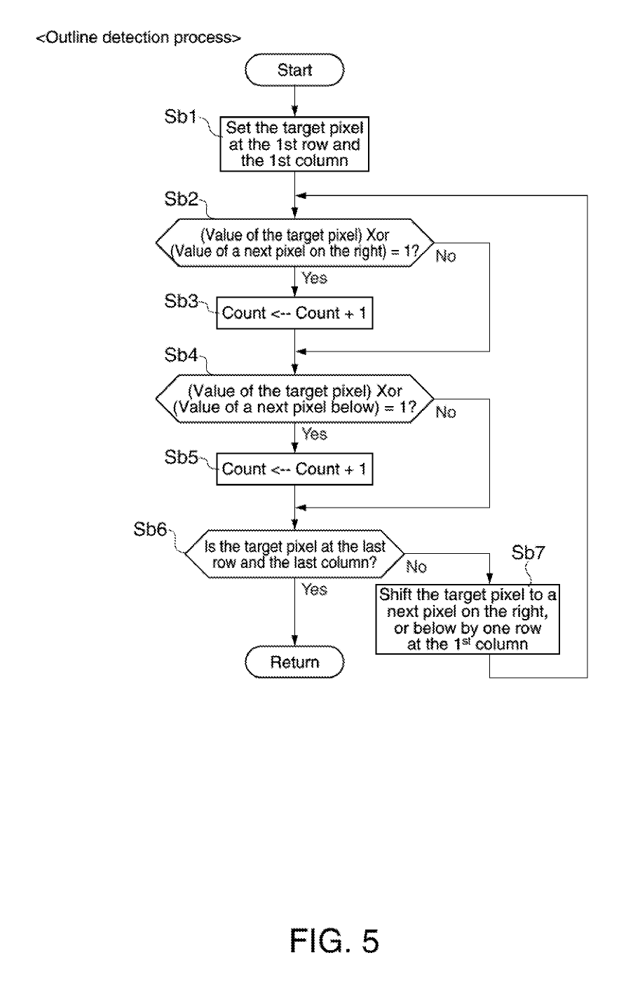

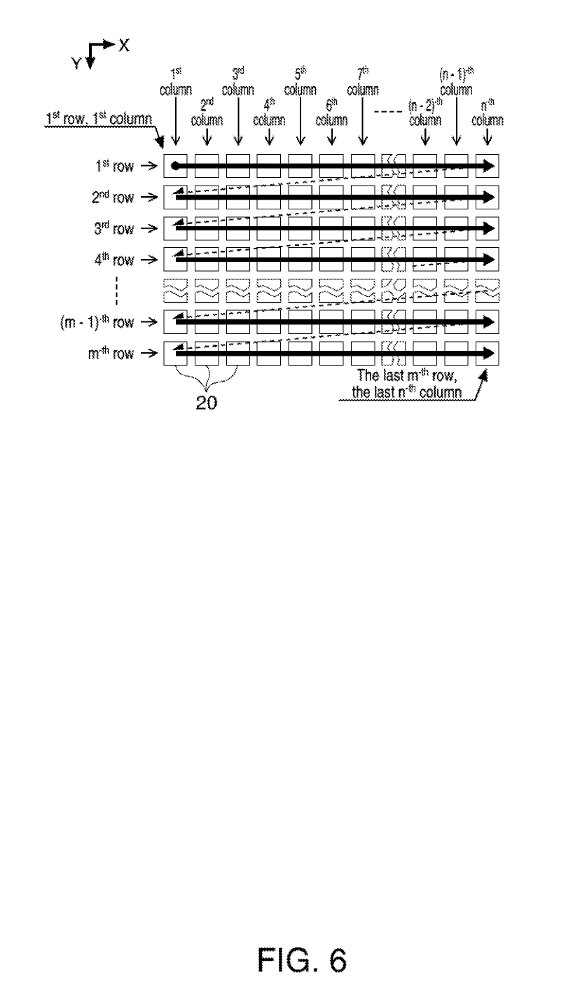

FIG. 5 is a flow chart showing details of the outline extraction process. First, in step Sb1, the general control unit 62 sets a target pixel at the first row and the first column. The target pixel is a pixel that is expediently targeted for detecting an outline. More specifically, as shown in FIG. 6, the target pixel is shifted from the 1^{st} row and the 1^{st} column to the 1^{st} row and the n^{-th} column, the 2^{nd} row and the 1^{st} column to the 2^{nd} row and the n^{-th} column, the 3^{rd} row and the 1^{st} column to the 3^{rd} row and the n^{-th} column, . . . , the (m−1)^{-th} row and the 1^{st} column to the (m−1)^{-th} row and the n^{-th} column, through the m^{-th} row and 1^{st} column to the m^{-th} row and the n^{-th} column in this order. In step Sb11, the target pixel is set at the 1^{st} row and the 1^{st} column as an initial value. In step Sb2, the general control unit 62 reads the pixel value of the target pixel and the pixel value of a next pixel located on the right set among the first VRAM 51, and judges as to whether or not the exclusive OR (Xor) of the two pixel values is “1.” Here, the pixel value designates a gradation of the corresponding pixel, and may be “1” to designate white and “0” to designate black, in the case of binary values like the present embodiment.

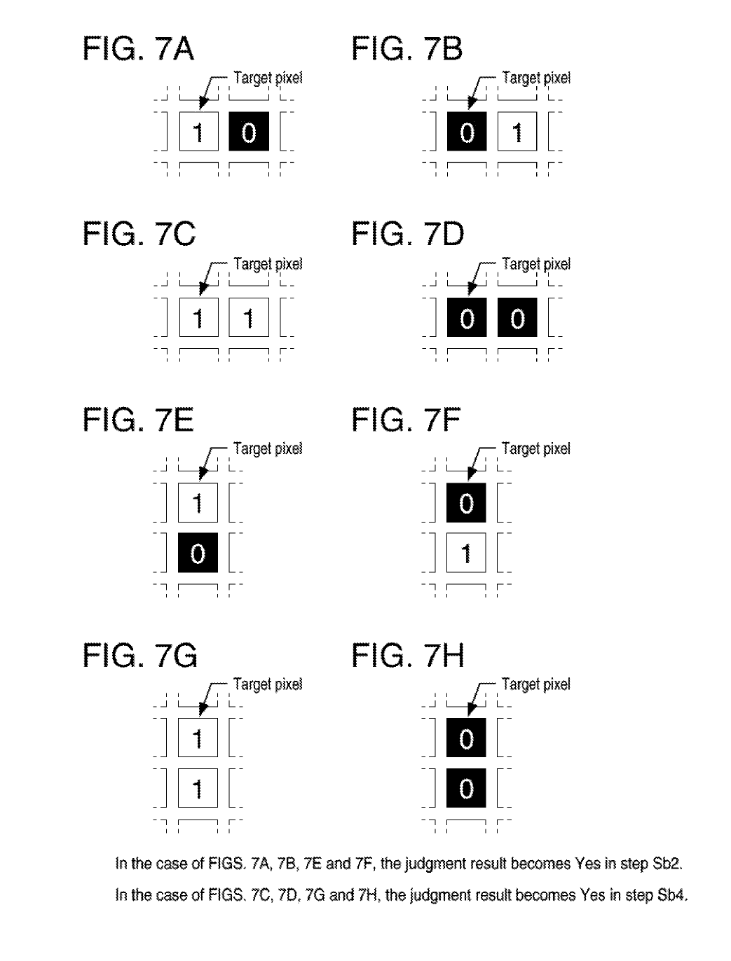

For this reason, in step Sb2, there are two cases in which the exclusive OR of the two pixel values is “1.” More specifically, the first case is where the pixel value of the target pixel is “1” and the pixel value of a next pixel on the right is “0” as shown in FIG. 7A, and the second case is where the pixel value of the target pixel is “0” and the pixel value of a next pixel on the right is “1” as shown in FIG. 7B. In either of the cases, the general control unit 62 increments the variable Count by “1” in step Sb3. On the other hand, in step Sb2, there are also two cases where the exclusive OR of the two pixel values is not “1,” in other words, when it is “0.” More specifically, the first case is where the pixel value of the target pixel and the pixel value of a next pixel on the right are both “1” as shown in FIG. 7C, and the second case is where the pixel value of the target pixel and the pixel value of a next pixel on the right are both “0” as shown in FIG. 7D. In either of the cases, the general control unit 62 skips an increment process in step Sb3.

In step Sb2, it is judged as to whether or not an outline is formed between a target pixel and a pixel on the right. A similar judgment operation is also executed for the target pixel and an adjacent pixel below the target pixel. This operation is executed in step Sb4. More specifically, in the step Sb4, the general control unit 62 reads the pixel value of the target pixel and the pixel value of an adjacent pixel located below the target pixel, and judges as to whether or not the exclusive OR (Xor) of the two pixel values is “1.”

Here, in step Sb4, there are two cases in which the exclusive OR of the two pixel values is “1.” More specifically, the first case is where the pixel value of the target pixel is “1” and the pixel value of an adjacent pixel below is “0” as shown in FIG. 7E, and the second case is where the pixel value of the target pixel is “0” and the pixel value of an adjacent pixel below is “1” as shown in FIG. 7F. In either of the cases, the general control unit 62 increments the variable Count by “1” in step Sb5. On the other hand, in step Sb4, there are also two cases where the exclusive OR of the two pixel values is “0.” More specifically, the first case is where the pixel value of the target pixel and the pixel value of an adjacent pixel below are both “1” as shown in FIG. 7G, and the second case is where the pixel value of the target pixel and the pixel value of an adjacent pixel below are both “0” as shown in FIG. 7H. In either of the cases, the general control unit 62 skips an increment process in step Sb5.

Then, in step Sb6, the general control unit 62 judges as to whether or not the target pixel at the moment is at the m^{-th} row and the n^{-th} column, in other words, at the last row and the last column. If the judgment result is “No,” then in step Sb7, the general control unit 62 moves the target pixel to a next pixel on the right. If the target pixel is at the right end in the matrix arrangement, in other words, only when it is at the last n^{-th} column, the target pixel is moved to a pixel located in the next row below at the first column. Then, the processing returns to step Sb2. On the other hand, when the judgment result in step Sb6 is “Yes,” it means that the variable Count has been counted for sections where white pixels and black pixels are placed next to each other in the horizontal direction or the vertical direction, and the outline detection process ends.

It is noted that no pixel exists on the right side of the pixel in the last n^{-th} column. Therefore, when the target pixel is at the n^{-th} column, the step Sb2 is not executed, and only the step Sb4 is executed. Similarly, no pixel exists below the last m^{-th} row. Therefore, when the target pixel is at the m^{-th} row, the step Sb4 is not executed, and only the step Sb2 is executed. Also, the extraction function to extract an outline is realized by the judgment process in the step Sb2 and the step Sb4 shown in FIG. 5, and when the judgment results are “Yes,” the counting function is realized by the process of incrementing the variable Count. Also, the judgment function is realized by the process of judging the variable Count in the step Sa3 in FIG. 4.

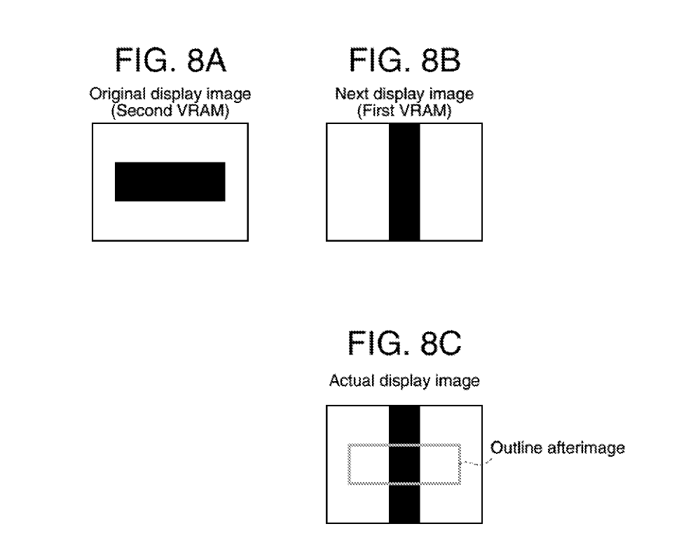

Next, more concrete operations of the electro-optical device 1 will be described, using an example in which a display image shown in FIG. 8A is changed to a display image shown in FIG. 8B. As described above, when the variable Count exceeds the threshold value Th1 when a display image on the display unit 10 is changed, the display image is rewritten by refresh drive (step Sa4).

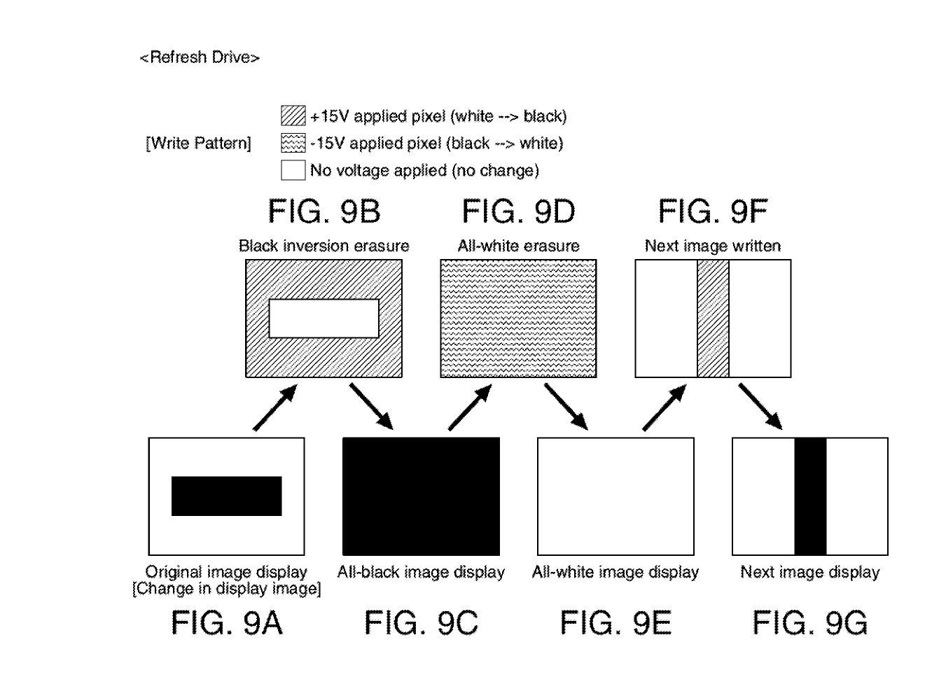

Such refresh drive will be described with reference to FIGS. 9A-9G. First, the image before change is shown in FIG. 9A, which is the same as the image shown in FIG. 8A, and is reflected on the content stored in the second VRAM 52. Next, the refresh drive control unit 66 controls the scanning line drive circuit 130 and the data line drive circuit 140 such that, in the image before rewritten, i.e., the image stored in the second VRAM 52, the white pixels are inverted to the black pixels. More specifically, the refresh drive control unit 66 controls the scanning line drive circuit 130 to select the scanning lines 112 at the first row, the second row, the third row, . . . , the (m−1)^{-th} row and the m^{-th} row, in this order. Further, the refresh drive control unit 66 controls the data line drive circuit 140, referring to the stored content in the second VRAM 52, to apply a voltage of +15 to those of the data lines 114 including pixels located in the selected scanning line 112 whose pixel value is “1,” and apply a voltage of 0V to those of the data lines 114 including pixels whose pixel value is “0” (in other words, to make them to have the same potential as the common electrode 36). It is noted that those of the pixels whose pixel value is “0” may be controlled to have a high impedance state (a floating state) so as not to be electrically connected to any sections by switching off the corresponding data lines 114. When selected, the scanning line 112 turns to a high level, and TFTs whose gate electrodes are connected to the selected scanning line turn on (placed in a conductive state), such that the pixel electrodes 32 are placed in a state being electrically connected to the data lines. As a result, those of the pixels that are originally in white color are inverted to black color due to an inversion of the direction of the electric field. On the other hand, those of the pixels that are originally in black color remain to be in black color as no electric field is generated. Therefore, by this control, all of the pixels turn to black color, as indicated in FIG. 9C. In this example, the scanning lines 112 are sequentially selected from the first row, but the selection can be skipped for any of the scanning lines 112 having no change.

Next, the refresh drive control unit 66 controls the scanning line drive circuit 130 and the data line drive circuit 140 such that, this time, all of the pixels are inverted from black color to white color, as indicated in FIG. 9D. More specifically, the refresh drive control unit 66 controls the scanning line drive circuit 130 to sequentially select the scanning lines 112, and controls the data line drive circuit 140 to apply a voltage of −15V to the data line 114 in each of the columns. By this control, this time, all of the pixels turn to white color, as indicated in FIG. 9E.

Then, the refresh drive control unit 66 controls the scanning line drive circuit 130 and the data line drive circuit 140 to write an image after rewritten, in other words, pixels to be appeared in black color, as shown in FIG. 9F. More specifically, the refresh drive control unit 66 controls the scanning line drive circuit 130 to sequentially select the scanning lines 112, and controls the data line drive circuit 140, referring to the stored content in the first VRAM 51, to apply a voltage of +15 to those of the data lines 114 including pixels located in the selected scanning line 112 whose pixel value is “0,” and apply a voltage of 0V to those of the data lines 114 including pixels whose pixel value is “1.” As a result, those of the pixels whose pixel electrodes are applied with a voltage of +15V are inverted to black color due to an inversion of the direction of the electric field. On the other hand, those of the pixels on those of the data lines 114 that are at 0V when selected maintain white color, as no change is generated in the direction of the electric field. Therefore, as indicated in FIG. 9G, a display state that reflects the stored contents in the first VRAM 51 is obtained.

By the refresh drive, all of the pixels are switched to black color, and then all of the pixels are switched to white color. Therefore, even when white pixels and black pixels are located next to each other in an original image, and the electric field on one of the pixels influences the other of the pixels, such influence can be removed. Then, black color pixels are written anew in the state in which the influence is removed, such that a correct display, as shown in FIG. 8B or FIG. 9G, can be obtained without generating an outline afterimage shown in FIG. 8C.

On the other hand, when the variable Count is less than the threshold value Th1 when a display image on the display unit 10 is changed, the display image is rewritten by differential drive (step Sa6), instead of refresh drive.

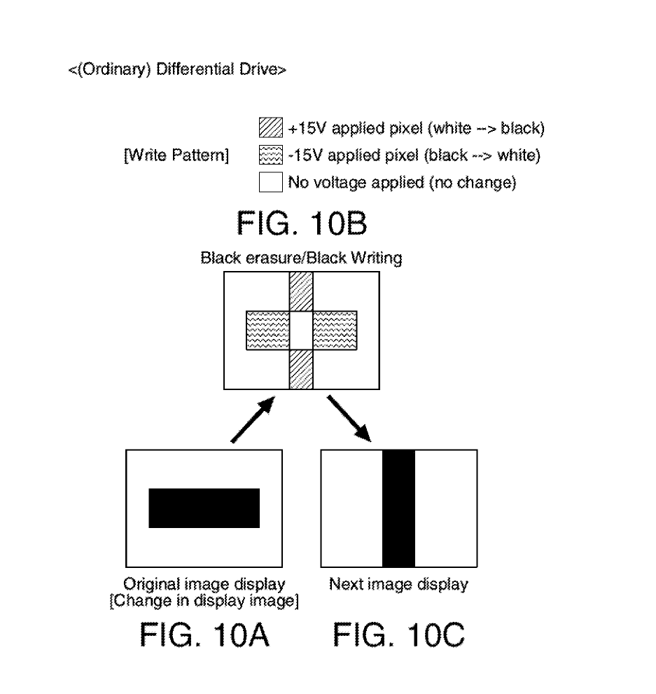

The differential drive will be described with reference to FIGS. 10A-10C. First, an image before change is shown in FIG. 10A, which is the same as the image shown in FIG. 8A, and is reflected on the stored content of the second VRAM 52. The differential drive control unit 68 compares images before and after rewriting, and controls the scanning line drive circuit 130 and the data line drive circuit 140 such that, as shown in FIG. 10B, only pixels to be changed are inverted. More specifically, the differential drive control unit 68 controls the scanning line drive circuit 130 to select the scanning lines 112 at the 1^{st} row, the 2^{nd} row, the 3^{rd} row, . . . , the (m−1)^{-th} row and the m^{-th} row, in this order. Further, the differential drive control unit 68 refers to the first VRAM 51 and the second VRAM 52, and controls the data line drive circuit 140 to apply a voltage of −15V to those of the data lines 114 including pixels located in the selected scanning line 112 whose pixel value changes from “0” to “1,” apply a voltage of +15V to those of the data lines 114 including pixels whose pixel value changes from “1” to “0,” and apply a voltage of 0V to those of the data lines including pixels whose pixel value does not change. As a result, those of the pixels whose pixel electrodes are applied with a voltage of −15V or +15V are inverted in color due to an inversion of the direction of the electric field. On the other hand, those of the pixels whose pixel electrodes are applied with a voltage of 0V maintain the original state as no change is generated. Therefore, as indicated in FIG. 10C, a display state that reflects the stored contents in the first VRAM 51 is obtained.

According to the differential drive, only pixels that are to be changed are rewritten, such that the power would not be wastefully consumed. Also, when a display image is to be changed, the differential drive is executed only when the variable Count is less than the threshold value Th1, such that an afterimage originated from an outline would not become conspicuous. Furthermore, there are other advantages in the differential drive. Fewer driving steps are executed, compared to the refresh drive, such that the differential drive is faster, and at least a part of the pixels turns to a black state and another part of the pixels turns to a white state, such that flickers are more difficult to be recognized by the observer, compared to the refresh drive.

In this manner, according to the present embodiment, when a change occurs in the display content on the display unit 10, if the integrated value obtained by counting sections where white pixels and black pixels are placed next to each other since the last refresh drive exceeds the threshold value Th1, the refresh drive is executed, and if the integrated value is less than the threshold value Th1, the differential drive is executed. Therefore, in accordance with the present embodiment, high-quality display with reduced afterimage and lower power consumption can both be accomplished. Furthermore, high-speed display switching can be achieved, which is effective in reducing flickers.

The first embodiment is configured in a manner that the main flow shown in FIG. 4 is executed with a change in display contents as a trigger, but may be configured in a manner that the main flow is executed at a predetermined time interval. In such a configuration, when the variable Count exceeds the threshold value Th1, the refresh drive is executed, but the same image is written even after the refresh drive has been executed.

### Second Embodiment

In the first embodiment described above, when the integrated value of counted sections where white pixels and black pixels are placed next to each other since the last refresh drive exceeds the threshold value Th1, a refresh drive is executed. For this reason, when changes occur multiple times in the display content, and the integrated value is less than the threshold value Th1, the refresh drive will not be executed. In this case, if the state in which white pixels and black pixels are placed next to each other at the same locations appears each time the display content is changed, afterimages remain at the same locations, and therefore their influence is believed to be small. However, in the first embodiment, if white pixels and black pixels are placed next to each other multiple times at the same locations, these locations are counted repeatedly, and there is a possibility that refresh drives may be frequently executed, which leaves room for improvement.

The second embodiment that improves the aspect discussed above will be described. An electro-optical device in accordance with the second embodiment includes the outline detection process whose content in accordance with the first embodiment (step Sa7 in FIG. 4 and FIG. 5) is modified. Also, in the step Sa5 in the main flow (see FIG. 4), the variable Count is reset to zero, and all boundary flags are also reset to zero. The boundary flags are flags that are provided for boundaries between pixels 20 arranged in a matrix of m rows×n columns, and each of the flags indicates as to whether or not two pixels sandwiching a boundary have become white color and black color, and the boundary has become an outline portion since the last refresh drive up to the present moment.

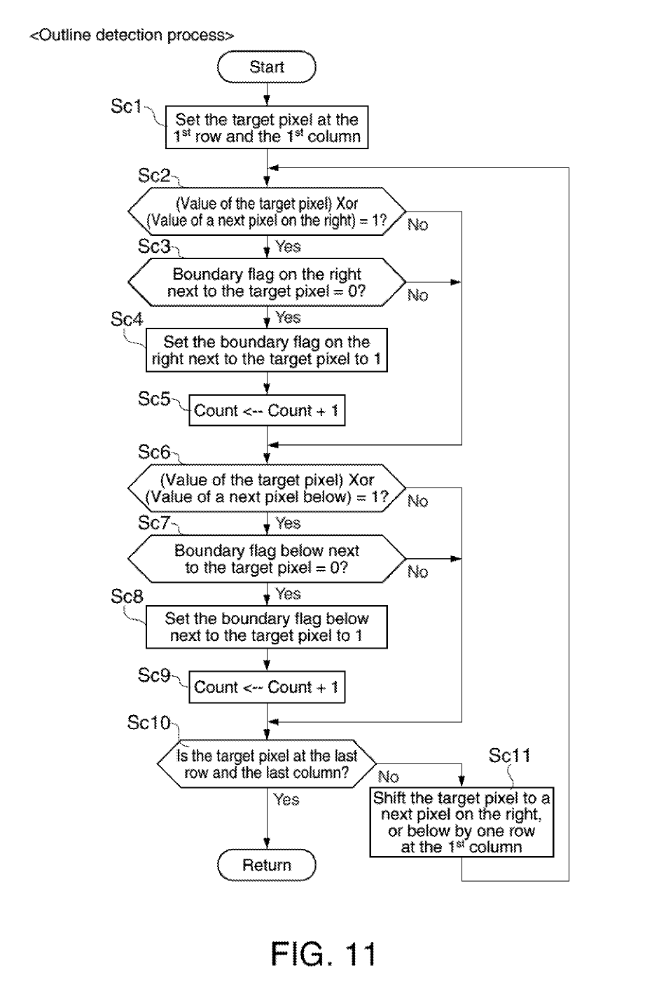

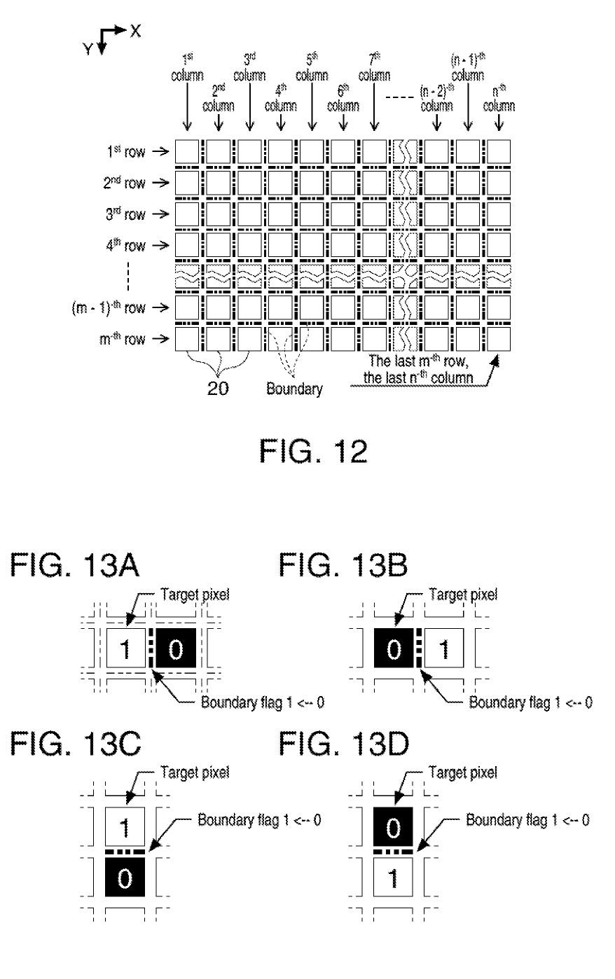

FIG. 11 is a flow chart showing the outline detection process in accordance with the second embodiment. First, in step Sc1, the general control unit 62 sets the target pixel at the 1^{st} row and the 1^{st} column. Then, in step Sc2, the general control unit 62 reads, from among the first VRAM 51, the pixel value of the target pixel and the pixel value of a next pixel located on the right of the target pixel, and judges as to whether or not the exclusive OR (Xor) of the two pixel values is “1.” If the judgment result is “No,” both of the pixels are in the same color of white or black, and therefore do not form an outline. Therefore, the process skips to step Sc6 to be discussed later. On the other hand, if the judgment result is “Yes,” one of the two pixels is white and the other is black, thereby forming an outline.

Therefore, in step Sc3, the general control unit 62 judges as to whether or not the boundary flag corresponding to the right side next to the target pixel is “0.” If the judgment result is “No,” the process skips to step Sc6 to be discussed later. On the other hand, if the judgment result is “Yes,” the general control unit 62 sets, in step Sc4, the boundary flag corresponding to the right side next to the target pixel to “1.” Here, the boundary flag corresponding to the right side next to the target pixel was reset to zero immediately after the last refresh drive (step Sa4), and would not be set to “1” other than in step Sc4. Therefore, when the judgment results in step Sc2 and the step Sc3 are both “Yes,” it means that the target pixel and the next pixel on the right have formed an outline portion of an image for the first time since the last refresh drive until the current judgment. Therefore, in this case, in step Sc5, the general control unit 62 increments the variable Count by “1.”

It is noted that there are two cases in which the variable Count is incremented in the step Sc5 as follows. As shown in FIG. 13A, the first case is where the pixel value of the target pixel is “1,” the pixel value of a next pixel on the right is “0,” and the boundary flag corresponding to the right side next to the target pixel has been “0.” As shown in FIG. 13B, the second case is where the pixel value of the target pixel is “0,” the pixel value of a next pixel on the right is “1,” and the boundary flag corresponding to the right side next to the target pixel has been “0.” Also, even if the target pixel and the next pixel on the right form an outline portion of an image again after the boundary flag corresponding to the right side next to the target pixel is set to “1” before the next refresh drive is executed, the judgment result in the step Sc3 becomes “No” such that the increment process in the step Sc5 is skipped. For this reason, even when the same section forms an outline, the variable Count would not be counted repeatedly.

A similar judgment operation is also executed for a pixel located below next to the target pixel. In other words, in step Sc6, the general control unit 62 reads, from among the first VRAM 51, the pixel value of the target pixel and the pixel value of a pixel located below next to the target pixel, and judges as to whether or not the exclusive OR (Xor) of the two pixel values is “1.” If the judgment result is “No,” the process skips to step Sc10 to be discussed later. On the other hand, if the judgment result is “Yes,” the general control unit 62 judges in step Sc7 as to whether or not the boundary flag corresponding to the lower side next to the target pixel is “0.” If the judgment result is “No,” the process skips to step Sc10. On the other hand, if the judgment result is “Yes,” the general control unit 62 sets, in step Sc8, the boundary flag corresponding to the lower side next to the target pixel to “1.” When the judgment results in step Sc6 and the step Sc7 are both “Yes,” it means that the target pixel and the next pixel below have formed an outline portion of an image for the first time since the last refresh drive until now. Therefore, in this case, in step Sc9, the general control unit 62 increments the variable Count by “1.”

It is noted that there are two cases in which the variable Count is incremented in the step Sc9 as follows. As shown in FIG. 13C, the first case is where the pixel value of the target pixel is “1,” the pixel value of a next pixel below is “0,” and the boundary flag corresponding to the lower side next to the target pixel has been “0.” As shown in FIG. 13D, the second case is where the pixel value of the target pixel is “0,” the pixel value of a next pixel below is “1,” and the boundary flag corresponding to the lower side next to the target pixel has been “0.” Also, even if the target pixel and the next pixel below form an outline portion of an image again after the boundary flag corresponding to the lower side next to the target pixel is set to “1” before the next refresh drive is executed, the judgment result in the step Sc7 becomes “No” such that the increment process in the step Sc9 is skipped. For this reason, even when the same section forms an outline, the variable Count would not be counted repeatedly.

In step Sc10, the general control unit 62 judges as to whether or not the target pixel at the present time is at the m^{-th} row and the n^{-th} column. When the judgment result is “No,” the general control unit 62 shifts, in step Sc11, the target pixel to the next pixel on the right. Only when it is at the last n^{-th} column, the target pixel is shifted to a pixel located in the next row below at the first column. Then, the process returns to step Sb2. On the other hand, when the judgment result in step Sb10 is “Yes,” it means that the variable Count has been counted for sections which have formed outlines for the first time since the previous refresh drive, and therefore the outline detection process ends.

According to the second embodiment, when changes occur in the display content of the display unit 10, the variable Count is counted only when white pixels and black pixels are placed next to each other for the first time since the last refresh drive. If the variable Count exceeds the threshold value Th1, a refresh drive is executed, and if it is less than the threshold value Th1, a differential drive is executed. Therefore, according to the second embodiment, it is possible to improve the situation of frequently executing refresh drives.

### Third Embodiment

The cause of afterimages described above will be once again examined. When a white pixel and a black pixel are placed next to each other, the electric field on one of the pixels influences the other pixel, and therefore an afterimage is supposed to be generated at this moment. However, as long as the state in which the white pixel and the black pixel are next to each other is visually recognized in an emphasized manner, it is thought that the afterimage that is supposed to be occurring would in effect not be conspicuous. In other words, the afterimage becomes conspicuous not when the white pixel and the black pixel are placed next to each other, but when the two pixels in different colors placed next to each other transfer to the same color, and a color (afterimage) different from the color after transfer would exist, which is thought to make the afterimage conspicuous. In the first embodiment described above, occurrences in which white pixels and black pixels are placed next to each other are added up, while, in the second embodiment, occurrences in which white pixels and black pixels are placed next to each other for the first time since the last refresh drive are added up, and when the integrated value (the variable Count) exceeds the threshold value Th1, the refresh drive is executed. Therefore, in accordance with the first embodiment or the second embodiment, there is still a possibility of executing refresh drives even when afterimages are not so conspicuous, which still leaves room for improvement.

Next, a third embodiment which improves the aspect described above will be described. An aspect of an electro-optical device in accordance with the third embodiment may be summarized as follows. When there is a section where two mutually adjacent pixels switch to the same color due to a change in the display content, and one of the pixels is a white pixel and the other is a black pixel in the state before the change is made, such a section is considered to cause an afterimage to be conspicuous due to the change, and the variable Count is counted for such a section. It is noted that the third embodiment includes the outline detection process whose content in accordance with the first embodiment is modified, like the second embodiment. Also, in the step Sa5 in the main flow (see FIG. 4), the variable Count is reset to zero, and all boundary flags are also reset to zero, which are generally the same as the second embodiment.

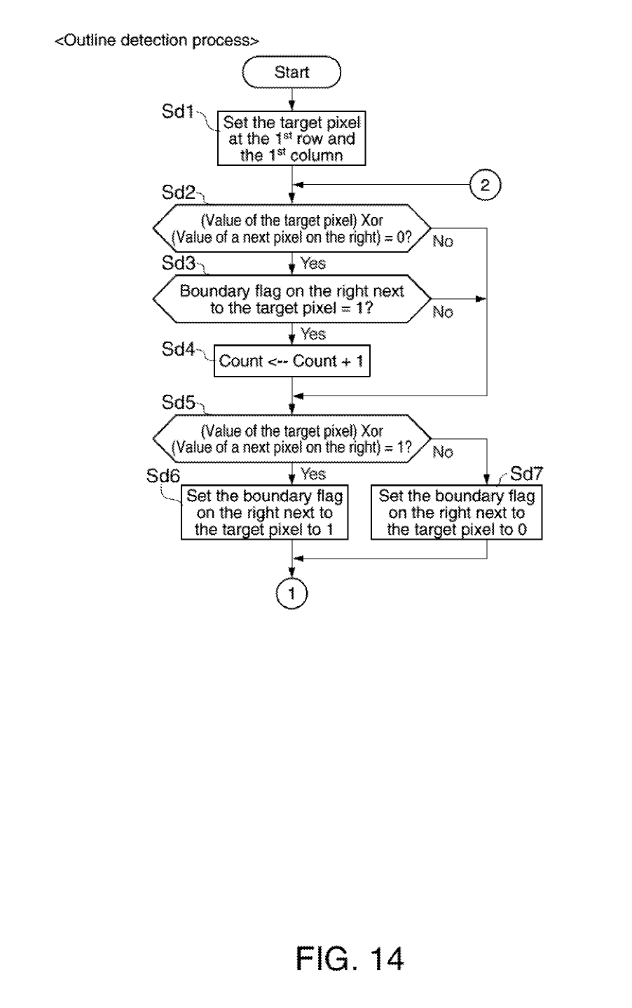

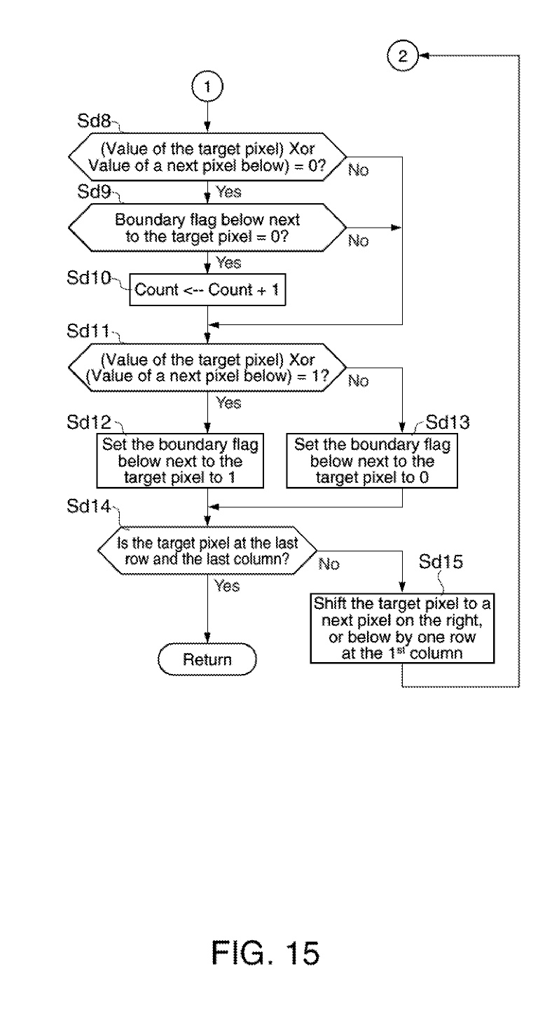

FIG. 14 and FIG. 15 are flow charts showing an outline detection process in accordance with the third embodiment. First, in step Sd1, the general control unit 62 sets the target pixel at the Pt row and the Pt column. Then, in step Sd2, the general control unit 62 reads, from among the first VRAM 51, the pixel value of the target pixel and the pixel value of a pixel located next on the right of the target pixel, and judges as to whether or not the exclusive OR (Xor) of the two pixel values is “0.” If the judgment result is “No,” which indicates that both of the pixels are in different colors, the process skips to step Sd5 to be discussed later. On the other hand, if the judgment result is “Yes,” this indicates that both of the pixels are in the same color in white or black. Therefore, in step Sd3, the general control unit 62 further judges as to whether or not a boundary flag corresponding to the section on the right side of the target pixel is “1.”

The boundary flag in the third embodiment is slightly different in definition from that of the second embodiment. Specifically, the boundary flag in the third embodiment is similar to the second embodiment in that it is provided at a section corresponding to a boundary between pixels, but different from the second embodiment in that a boundary flag that is once set at “1” after having been reset to zero at the last reset drive may be reset again to “0.” Simply put, when the boundary flag in accordance with the third embodiment is “1,” it indicates that, in the state before the display content is changed, one of the two pixels interposing the boundary is white, and the other is black. For this reason, when the judgment results in the steps Sd2 and Sd3 are both “Yes,” the target pixel and the pixel on the right mutually turn to the same color due to a change in the display content, and one of them is a white pixel and the other is a black pixel in the state before the change is made. Therefore, in this case, in step Sd4, the general control unit 62 increments the variable Count by “1.”

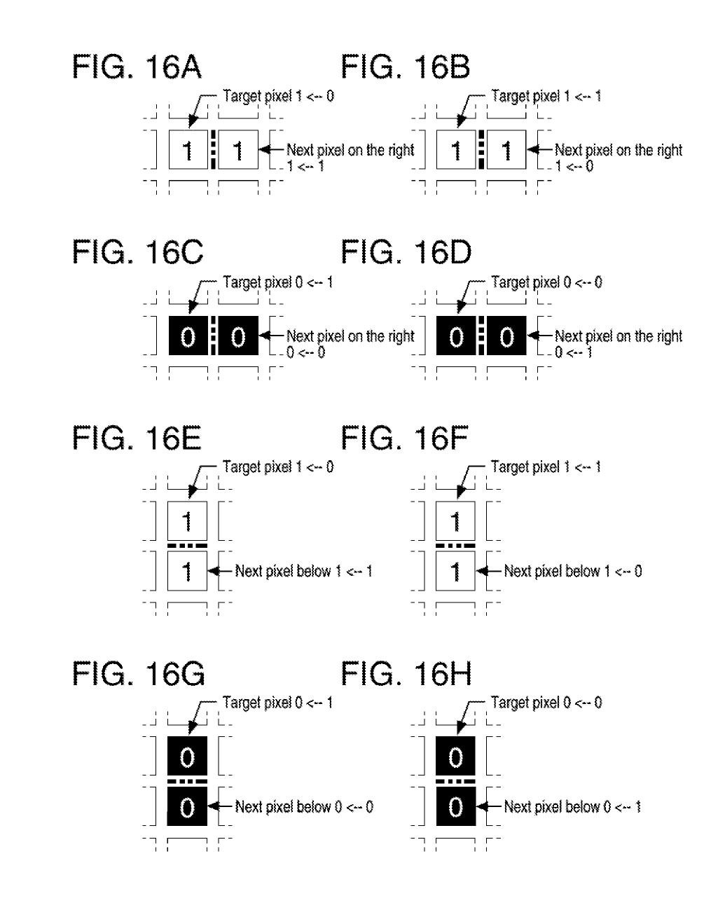

It is noted that there are four cases in which the variable Count is incremented in the step Sd4 as follows. As shown in FIG. 16A, the first case is where the pixel value of the target pixel is changed from “0” to “1,” and the pixel value of a next pixel on the right is not changed from “1.” As shown in FIG. 16B, the second case is where the pixel value of the target pixel is not changed from “1,” and the pixel value of a next pixel on the right is changed from “0” to “1.” As shown in FIG. 16C, the third case is where the pixel value of the target pixel is changed from “1” to “0,” and the pixel value of a next pixel on the right is not changed from “0.” As shown in FIG. 16D, the fourth case is where the pixel value of the target pixel is not changed from “0,” and the pixel value of a next pixel on the right is changed from “1” to “0.” In each of the four cases, the boundary flag corresponding to a section next on the right of the target pixel is “1.”

Then, the general control unit 62 executes a process to reflect the state of the current target pixel and the next pixel on the right to a boundary flag corresponding to a section on the right next to the target pixel, to be ready for the next execution of the step Sd3 for the same section. This process corresponds to steps Sd5-Sd7. More specifically, the general control unit 62 judges as to whether or not the exclusive OR (Xor) of the pixel value of the target pixel and the pixel value of the next pixel on the right is “1” (step Sd5). If the judgment result is “Yes,” the general control unit 62 sets “1” at the boundary flag corresponding to a section on the right next to the target pixel (step Sd6), and resets it to “0” when the judgment result is “No” (step Sd7).

A similar operation is also executed for a pixel located below next to the target pixel. More specifically, in step Sd8 of FIG. 15, the general control unit 62 reads, from among the first VRAM 51, the pixel value of the target pixel and the pixel value of a pixel located below next to the target pixel, and judges as to whether or not the exclusive OR (Xor) of the two pixel values is “0.” If the judgment result is “No,” the process skips to step Sd11. On the other hand, if the judgment result is “Yes,” the general control unit 62 further judges in step Sd9 as to whether or not the boundary flag corresponding to the lower side next to the target pixel is “1.”

When the judgment results in steps Sd8 and Sd9 are both “Yes,” it means that the target pixel and the next pixel below mutually turn to the same color due to a change in the display content, and one of them is a white pixel and the other is a black pixel in the state before the change is made. Therefore, in this case, in step Sd10, the general control unit 62 increments the variable Count by “1.”

It is noted that there are also four cases in which the variable Count is incremented in the step Sd10 as follows. As shown in FIG. 16E, the first case is where the pixel value of the target pixel is changed from “0” to “1,” and the pixel value of a next pixel below is not changed from “1.” Second, as shown in FIG. 16F, the second case is where the pixel value of the target pixel is not changed from “1,” and the pixel value of a next pixel below is changed from “0” to “1.” As shown in FIG. 16G, the third case is where the pixel value of the target pixel is changed from “1” to “0,” and the pixel value of a next pixel below is not changed from “0.” As shown in FIG. 16H, the fourth case is where the pixel value of the target pixel is not changed from “0,” and the pixel value of a next pixel below is changed from “1” to “0.” In each of the four cases, the boundary flag corresponding to a section below next to the target pixel is “1.”

Then, to be ready for the next execution of the step Sd9 for the same section, the general control unit 62 judges as to whether or not the exclusive OR (Xor) of the pixel value of the target pixel and the pixel value of the next pixel below is “1” (step Sd11). If the judgment result is “Yes,” the general control unit 62 sets “1” at the boundary flag corresponding to a section below next to the target pixel (step Sd12), and resets it to “0” when the judgment result is “No” (step Sd13).

In step Sd14, the general control unit 62 judges as to whether or not the target pixel at the present time is at the m^{-th} row and the n^{-th} column. When the judgment result is “No,” the general control unit 62 shifts, in step Sd15, the target pixel to a next pixel on the right. Only when it is at the last n^{-th} column, the target pixel is shifted to a pixel located in the next row below at the first column. Then, the process returns to step Sd2 in FIG. 14. On the other hand, when the judgment result in step Sd14 is “Yes,” the outline detection process ends.

According to the third embodiment, when a change occurs in the display content, the variable Count is counted for only a section where adjacent two pixels mutually turn to the same color due to the change, and the two pixels in the state prior to the change form an outline. If the variable Count exceeds the threshold value Th1, a refresh drive is executed. If the variable Count is less than the threshold value Th1, a differential drive is executed. Therefore, according to the third embodiment, the condition in which a refresh drive is executed even though an afterimage is not so conspicuous can be improved.

Application and Modification

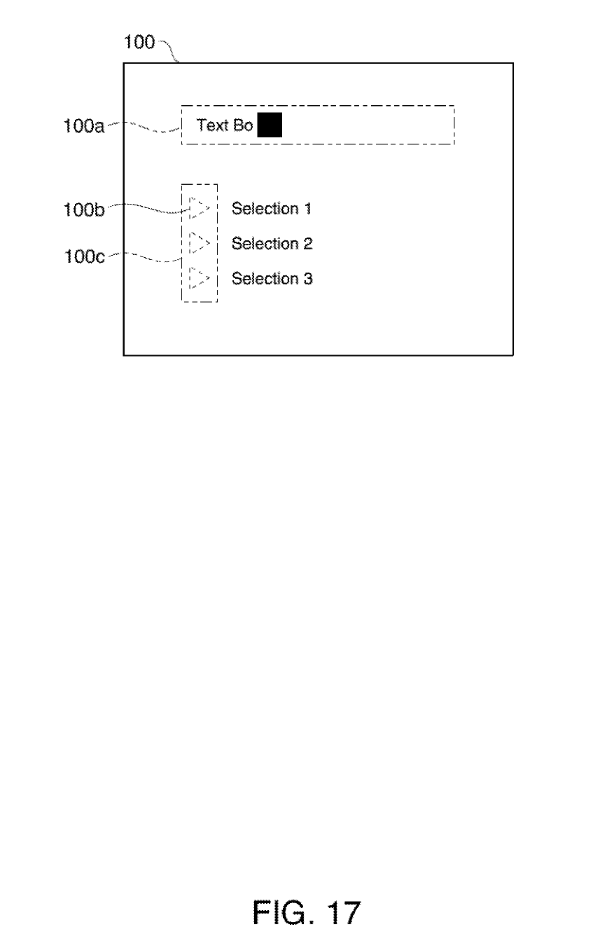

The invention is not limited to the embodiments described above, and the following applications and modifications are possible. As shown in FIG. 17, in a region 100a, such as, a text box in the display region 100, each time a character or a mark is inputted, a change occurs in its display content. Similarly, in a region 100c in which a cursor 100b is expected to be shifted, each time the cursor 100b is instructed to shift, a change occurs in the display content. Because an outline afterimage occurs with a change in the display content as a trigger, there is a higher possibility that afterimages occur in a concentrated manner in a region where the display content is frequently changed. Accordingly, the display region 100 may be divided into a plurality of regions. The extraction function, the counting function and the judgment function may be executed for each of the divided regions, and a refresh drive may be executed for only pixels included in a divided region where the variable Count exceeds the threshold value Th1. By this configuration, the pixels that are subjected to a refresh drive are limited, whereby the power consumption can be suppressed, and afterimages that may occur in a concentrated manner can be effectively reduced. Also, the region to be refresh-driven can be suppressed to the necessity minimum, such that flickers can be better suppressed, compared to the case where the entire display region 100 is refresh-driven. It is noted that the threshold value Th1 in this instance may be set according to the number of pixels included in each corresponding one of the divided regions. If there are any regions where the display content is not changed, such regions may be configured such that the extraction function, the counting function and the judgment function are not executed.

Further, in each of the embodiments, the display unit 10 displays binary values of white color and black color, but may be provided with a half-tone display capability. Even in the case of displaying half-tones, when an outline is formed by adjacent pixels having mutually different gradations, the electric field on one of the pixels influences the other pixel, which is thought to generate a similar afterimage. When displaying half-tones, one of the conditions for a section to be extracted as forming an outline, a difference between pixel values (gradation values, gradation levels) of two pixels may be used for judgment. Let us consider a case where, for example, the gradation levels are defined sequentially by means of brightness levels as black<dark gray<slightly dark gray<slightly light gray<light gray<white. In this case, when there is a great difference between two gradation values, for example, when a black or dark gray pixel is placed next to a white or light gray pixel, the influence of the electric field is greater, and therefore the variable Count may be incremented. On the other hand, when there is a small difference between two gradation values, for example, when a slightly dark gray pixel is placed next to a slightly light gray pixel, the influence of the electric field is smaller, and therefore the variable Count may not be incremented, or the variable Count may be incremented once for each plural sections. On the other hand, when pixels closer in gradation to black color appear in a white background, in particular, afterimages would more readily be visually recognized. In this case, the variable Count may be more preferentially incremented (by increasing the frequency of increment actions),

Further, in each of the embodiments described above, the outline extraction function, the counting function and the integrated value judgment function for a target pixel and an object pixel (an adjacent pixel on the right or an adjacent pixel below) are executed by the controller 60. However, an image to be displayed on the display unit 10 is specified by the control of the CPU that is an external device. For this reason, these functions may be executed by the CPU, or by a personal computer that is a host apparatus, and the controller 60 may be configured to control refresh drives and differential drives at the display unit 10 based on the results of these functions.

In each of the embodiments, a refresh drive or a differential drive is executed after extracting an outline between a target pixel and an object pixel. However, the invention is not limited to this configuration. For example, in a drive system in which, whether or not driving of each of the pixels is started is judged at each frame, and an image in each frame is updated, whether or not the variable Count exceeds the threshold value Th may be judged at each frame. If the variable Count exceeds the threshold value Th, the update in the frame may be interrupted, and driving of the pixels may be stopped. Thereafter, a refresh drive may be executed.

Also, the shape of each pixel electrode is not limited to a square or a rectangle, and may be a polygonal shape or a circular shape. Also, pixel electrodes may be segment electrodes in various shapes including 7 segment-shapes. When segment electrodes are used, for example, a data line may be directly connected to each of the segment electrodes, and the potential on each of the segment electrodes (pixel electrodes) may be controlled by the potential on each of the data lines. Even in these cases, sections where pixel electrodes with different gradations are placed next to each other may be counted, and whether or not the variable Count exceeds the threshold value Th may be judged. By this, effects similar to those of each of the embodiments described above can be obtained.

Each of the embodiments has been described, using a mode including steps of rewriting the entire pixels included in a predetermined region where an outline is to be extracted to a single gradation as an example of the refresh drive. However, the refresh drive is not limited to such a mode. For example, when an image A is displayed succeeding a refresh drive, the refresh drive may be in a mode including a first step of displaying a gradation-inverted image of the image A, and a second step of displaying the image A after the first step. Also in this case, the refresh step includes steps of rewriting pixels corresponding to sections counted in the outline extraction process (in other words, target pixels and object pixels with different gradations placed next to each other) to a single gradation, such that afterimages can be erased. Also, the refresh drive may have another mode that includes rewriting pixels corresponding to sections counted in the outline extraction process (in other words, target pixels and object pixels with different gradations placed next to each other) to at least a single gradation. Also in this case, afterimages can be erased by refresh drives.

Electronic Apparatus

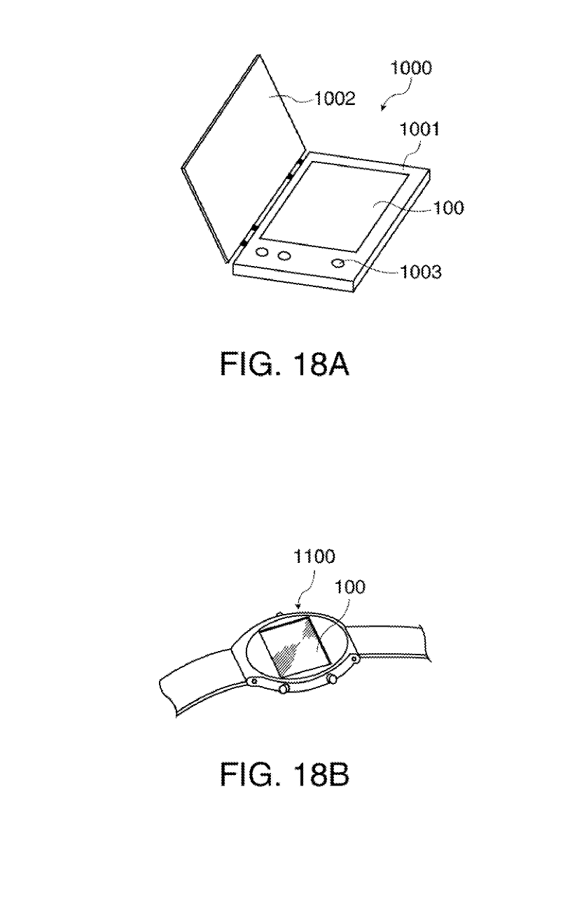

Next, examples of electronic apparatuses using an electro-optical device in accordance with any one of the embodiments described above will be described. FIG. 18A is a perspective view of an electronic book reader using the electro-optical device. The electronic book reader 100 is equipped with a book-shaped frame 1001, a cover 1002 provided in a manner freely opened and closed with respect to the frame 1001, an operation unit 1003, and an electro-optical device in accordance with any one of the embodiments described above. It is noted that, in the figure, only the display region 100 of the electro-optical device is exposed. With the electronic book reader 1000, contents of an electronic book are displayed in the display region 100, and pages of the electronic book can be turned by operating the operation unit 1003. Further, FIG. 18B is a perspective view of a wrist watch 110 using an electro-optical device in accordance with any one of the embodiments described above. The wrist watch 1100 is equipped with the electro-optical device in accordance with any one of the embodiments described above, and only its display region 100 is exposed. In the wrist watch 110, time, year, month and day are displayed in the display region 100. In addition to the above, other electronic apparatuses to which an electro-optical device in accordance with any one of the embodiments described above is applicable includes electronic paper, electronic notebooks, calculators, cellular phones and the like.

The entire disclosure of Japanese Patent Application No. 2011-020762, filed Feb. 2, 2011 is expressly incorporated by reference herein.

What is claimed is:

1. A control device for controlling a display unit that includes pixels each having display elements, the control device comprising:
a control unit counting sections where pixels with different gradations are placed next to each other in a predetermined region among an image to be displayed on the display unit,
wherein the control unit outputs an instruction to execute a refresh drive in the predetermined region when an integrated value of the sections exceeds a predetermined value.

2. A control device according to claim 1,
wherein the control unit outputs an instruction to rewrite the entire pixels included in the predetermined region to a single gradation when the integrated value exceeds the predetermined value, then the control unit outputs an instruction to rewrite a part of pixels in the predetermined region to a gradation different from the single gradation.

3. A control device according to claim 2,
wherein the control unit outputs an instruction to rewrite pixels to be changed in the predetermined region when the integrated value equals to the predetermined value or less.

4. A control device according to claim 1, comprising:
an extraction function that extracts sections where pixels with different gradations are placed next to each other in the predetermined region,
a counting function that counts the sections extracted by the extraction function, and
a judging function that judges as to whether or not an integrated value provided by the counting function exceeds the predetermined value.

5. A control device according to claim 4, wherein the extracting function extracts sections where pixels with different gradations are placed next to each other for the first time, after the last display of the pixels in the single gradation.

6. A control device for controlling a display unit that includes pixels each having display elements, the control device comprising:
a control unit counting sections where pixels with different gradations placed next to each other change to a single gradation in a predetermined region among an image to be displayed on the display unit,
wherein the control unit outputting an instruction to execute a refresh drive in the predetermined region when an integrated value of the sections exceeds a predetermined value.

7. A control device according to claim 1, wherein the predetermined region is composed of all or a part of the plurality of pixels in the display unit.

8. A control device according to claim 6, wherein the predetermined region is composed of all or a part of the plurality of pixels in the display unit.

9. A control device according to claim 1, wherein the refresh drive includes rewriting all of the pixels included in the predetermined region to a single gradation.

10. A control device according to claim 6, wherein the refresh drive includes rewriting all of the pixels included in the predetermined region to a single gradation.

11. An electro-optical device comprising:
the display unit recited in claim 1; and
the control device recited in claim 1.

12. An electro-optical device comprising:
the display unit recited in claim 6; and
the control device recited in claim 6.

13. An electro-optical device according to claim 11, wherein the refresh drive includes rewriting all of the pixels included in the predetermined region to a single gradation.

14. An electro-optical device according to claim 12, wherein the refresh drive includes rewriting all of the pixels included in the predetermined region to a single gradation.

15. An electronic apparatus comprising the electro-optical device recited in claim 13.

16. An electronic apparatus comprising the electro-optical device recited in claim 14.
